(19) United States
(12) Patent Application Publication
(10) Pub. No.: US 2016/0237644 A1
(43) Pub. Date: Aug. 18, 2016

(54) MOUNTING ASSEMBLY

(71) Applicant: Caterpillar Inc., Peoria, IL (US)

(72) Inventors: John G. Benson, Alsip, IL (US); William J. Hurst, Montgomery, IL (US); Matthew T. Hansen, Big Rock, IL (US); Jiping Jiang, Aurora, IL (US); Michael A. Brewer, Oswego, IL (US); Rajendra P. Vavilala, Montgomery, IL (US); Amory R. Diccion, Oswego, IL (US); Brian C. Howson, Aurora, IL (US); Jose M. Lopez, Lisle, IL (US)

(73) Assignee: Caterpillar Inc., Peoria, IL (US)

(21) Appl. No.: 15/137,717

(22) Filed: Apr. 25, 2016

(51) Int. Cl. E02F 9/08; B66C 1/66; B66C 1/10; B60K 5/12

(52) U.S. Cl. CPC E02F 9/0808; B60K 5/12; B66C 1/66; B66C 1/107; B60Y 2200/41

(57) ABSTRACT

A mounting assembly of a machine is disclosed. The mounting assembly including a bracket having a first portion adapted to mount an engine. The first portion having a first surface having an annular opening. A second portion is adapted for lifting operations. The second portion having a first end connected to the first portion, and a second end having an annular opening. The second portion is adapted to attach to a frame assembly of the machine. The bracket is manufactured as a single component.

### TECHNICAL FIELD

The present disclosure relates to an engine mounting assembly of a machine, and more specifically, to a structure of a bracket for mounting an engine on to a chassis frame of the machine.

### BACKGROUND

Machines such as, but not limited to, wheel loaders, or wheel dozers, are used in various industries such as earthmoving and construction industries, for excavating materials and loading the materials. Typically, these machines include a number of engine mounting brackets which are coupled to a frame assembly of the machine, and are structured to provide mounting support for an engine. The engine mounting brackets are also provided with a lift eye to assist in lifting and transportation of the frame assembly and the engine.

The engine mounting brackets are generally manufactured using fabrication methods. Typically, a number of steel plates are joined together through a welding process to form a mounting structure. For example, currently, an engine mount is formed using 4 plates and 2 threaded bosses, which are welded to form a mounting bracket. Similarly, a lifting eye is formed using a plate which extends through the frame assembly, and welded to the frame assembly. Thus, the engine mount and the lifting eye collectively require at least five plates welded together to correct dimensions and tolerances. Such a structure however, can be difficult to manufacture and may increase the cost of production. Therefore, there is a need for an engine mounting structure with a lifting hook provision which is cost effective, and easy to manufacture.

United States Publication Number 20080105638 hereinafter referred to as the '638 publication, discloses an engine removal system. The '638 publication discloses an engine mount which works in conjunction with a hoist mount. The engine mount is attached to an engine, and coupled to the hoist mount. The hoist mount is adapted to lift or lower the engine upon its actuation. The engine can be lifted upon raising of the hoist mount and can be lowered upon lowering of the hoist mount. Further, the engine hoist mount has vertical bars, inclined bars joined to the tops of the vertical bars, a horizontal bar joined between the tops of the inclined bars. In addition to the hoist mount, there is an engine framework, a lift mechanism, and front and rear mounts, used in conjunction with and as a part of the lift mechanism. The '638 publication further discloses that the engine mount has provisions to allow another lifting point to be secured to the rear engine mounts, thereby tying the entire framework together in a unified structure. However, such type of the structure disclosed in the reference can be expensive, and difficult to manufacture. Therefore, there is a need for a structure which is cost effective, and easy to manufacture.

### SUMMARY OF THE DISCLOSURE

In one aspect of the present disclosure, a mounting assembly of a machine is provided. The mounting assembly including a bracket having a first portion adapted to mount an engine. The first portion having a first surface having an annular opening. A second portion is adapted for lifting operations. The second portion having a first end connected to the first portion, and a second end having an annular opening. The second portion is adapted to attach to a frame assembly of the machine. The bracket is manufactured as a single component.

Other features and aspects of this disclosure will he apparent from the following description and the accompanying drawings.

### BRIEF DESCRIPTION OF THE DRAWINGS

FIG. 1 is a perspective view of a machine, in accordance with the concepts of the disclosure;

FIG. 2 is a perspective view of an engine assembly of the machine of FIG. 1, in accordance with the concepts of the present disclosure;

FIG. 3 is a perspective view of a mounting assembly showing a bracket attached to a frame assembly of the machine without an engine, in accordance with the concepts of the present disclosure;

FIG. 4 is a perspective view of the bracket showing a first portion and a second portion, in accordance with the concepts of the present disclosure;

FIG. 5 is a second embodiment of the bracket, in accordance with the concepts of the present disclosure; and

FIG. 6 is a third embodiment of the bracket, in accordance with the concepts of the present disclosure.

### DETAILED DESCRIPTION

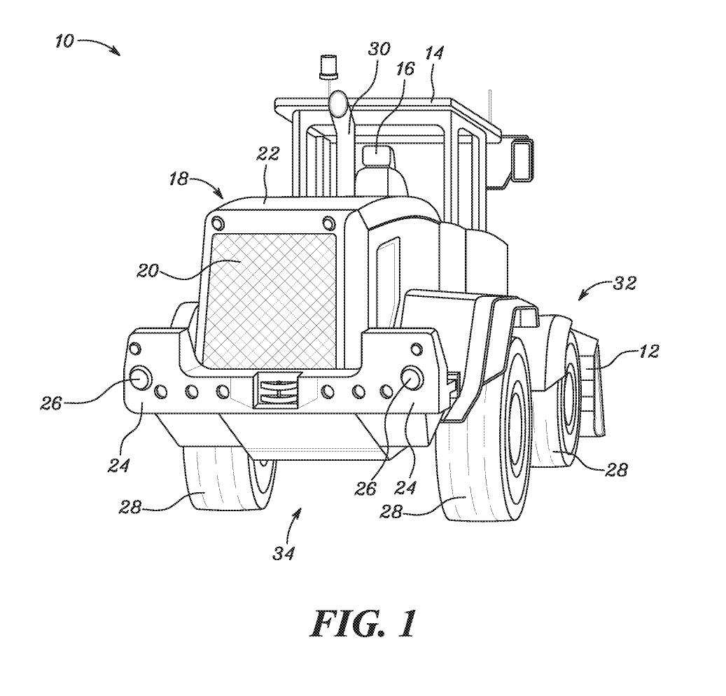

Referring to FIG. 1, a machine 10 includes a bucket 12, a cab 14, a driver seat 16, an engine assembly 18, a grill 20, a cover 22, a member 24, a number of lights 26, a number of wheels 28, and an exhaust conduit 30. The machine 10 further includes various other components such as, but not limited to, mirrors, or windows. For the purpose of simplicity, the various other components of the machine 10 are not labeled in FIG. 1. It will be apparent to one skilled in the art that the machine 10 shown in FIG. 1 is a wheel loader. However, the machine 10 may be any other wheeled machine including, but not limited to, a wheel dozer, or articulated trucks, without departing from the scope of the disclosure.

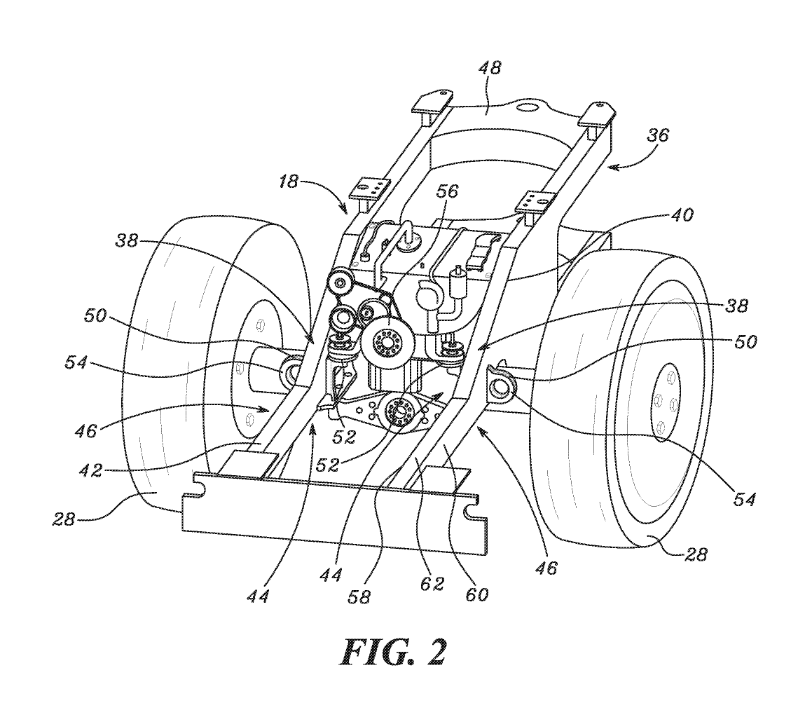

The machine 10 includes the bucket 12 which is placed at a first side 32 (i.e., a front side) of the machine 10, and is utilized for various operations such as, but not limited to, for loading materials. It will be apparent to one skilled in the art that the machine 10 may include a blade for moving earth on its front, and the machine 10 may steer through articulating its front and rear halves. The machine 10 further includes the cab 14 which has the driver seat 16 for an operator to be seated, and for operating the machine 10. Further, the machine 10 having the grill 20 (i.e., a radiator grill), the cover 22, and the member 24, which are attached at a second side 34 of the machine 10. The member 24 of the machine 10 incorporates the lights 26 which are utilized to illuminate an area around the machine 10. Further, the machine 10 has the wheels 28 which are utilized to drive the machine 10, and the exhaust conduit 30 through which exhaust flows out. The machine 10 further includes the engine assembly 18 which is disposed at the second side 34 (i.e., a rear side) of the machine 10. The detailed description of the engine assembly 18 is described later in conjunction with FIG. 2.

Referring. to FIG. 2, the engine assembly 18 of the machine 10 is coupled to a frame assembly 36 via a mounting assembly 38. The frame assembly 36 includes a first frame 40 and a second frame 42. Each of the first frame 40 and the second frame 42 has a corresponding first side 44 and a corresponding second side 46. The first frame 40 and the second frame 42 are coupled to each other by means of at least one cross-member 48. Further, the mounting assembly 38 having a pair of brackets 50 which are welded to the frame assembly 36. The bracket 50 having a first portion 52 and a second portion 54. The first portion 52 is adapted to mount an engine 56. It should be noted that the two brackets 50 are each welded to the first frame 40 and the second frame 42 of the frame assembly 36. In an embodiment, each of the first frame 40 and the second frame 42 is a box type frame. As an example, the first frame 40 may include a first plate 58, a second plate 60, a third plate 62, and a fourth plate (not shown) welded together to form the first frame 40. In such case, the bracket 50 is welded to the first plate 58 and the second plate 60, The bracket 50 is shaped such that the weld joints between the bracket 50 and each of the first plate 58 and the second plate 60 smoothly transition into a surface of the first plate 58 on the first side 44 and into a surface of the second plate 60 on the second side 46 of the first frame 40. It will be apparent to one skilled in the art that the bracket 50 is shaped such that it provides weld backing internal to the first frame 40, i.e. within a space between the first plate 58, the second plate 60, the third plate 62, and the fourth plate (not shown). The weld backing is provided on at least one of an interface between the bracket 50 and the first plate 58 or the second plate 60 of the first frame 40. This in turn ensures that the weld joint created between the bracket 50 and the first frame 40 is a full penetration weld,

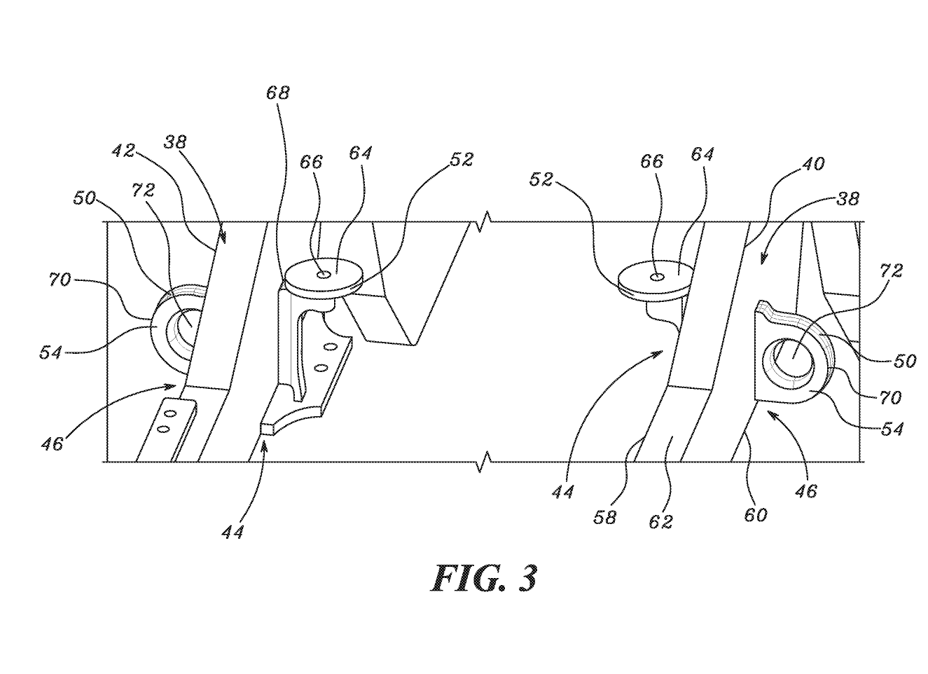

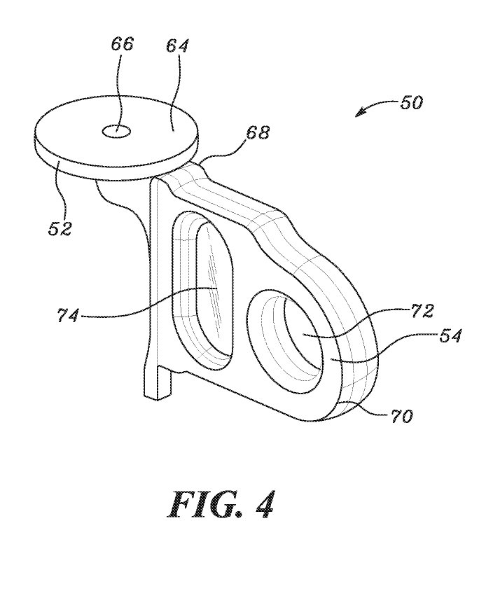

Referring to FIG. 3 & FIG. 4, the bracket 50 includes the first portion 52, and the second portion 54. It should be noted that the first portion 52 and the second portion 54, of the bracket 50, are integrated into a single component. The first portion 52 of the bracket 50 having a first surface 64 which has an annular opening 66. The annular opening 66 includes threads (not shown). According to one embodiment, the first surface 64 is circular in shape. On the other hand, the second portion 54 of the bracket 50 includes a first end 68 (shown in FIG. 4), and a second end 70. The first end 68 is connected to the first portion 52 of the bracket 50, and the second end 70 having an annular opening 72 which is utilized for lifting operations. It will be apparent to one skilled in the art that the lifting operations mentioned above are performed at the second side 34 of the machine 10. In an embodiment, the machine 10 may include lifting attachment points on the first side 32 of the machine 10 as well, to allow the machine 10 to be lifted level to the ground, without departing from the scope of the disclosure. Further, the second portion 54 of the bracket 50 includes a cavity 74, which is disposed in between the first plate 58 and the second plate 60 of the first frame 40 when the bracket 50 is welded to the first frame 40. Further, the second portion 54, is attached to the frame assembly 36 (shown in FIG. 3) of the machine 10.

Further, referring to FIG. 3, the first portion 52 of the bracket 50 is disposed at the first side 44 of the first frame 40 of the frame assembly 36. Further, the first portion 52 corresponds to an engine mounting portion, and is adapted to mount the engine 56. Further, the first portion 52 of the bracket 50 includes a rubber mount (not shown). On the other hand, the second portion 54 of the bracket 50 is disposed at the second side 46 of the first frame 40 of the frame assembly 36. Further, the bracket 50 includes a surface which is coupled to axle trunnion mount of the first frame 40. Further, the bracket 50 is self located in the first frame 40 by at least one of the first plate 58 or the second plate 60 when the bracket 50 is inserted between the first plate 58 and the second plate 60 of the first frame 40. As an example, a slot is provided on at least one of the first portion 52 and the second portion 54 of the bracket 50 so that the bracket 50 is self located in the first frame 40. It should be noted that coupling of one of the pair of brackets 50 on to the first frame 40 is explained above, however, it will be apparent to one skilled in art that another one of the pair of brackets 50 is coupled with respect to the second frame 42 in a similar manner, without departing from the scope of the disclosure.

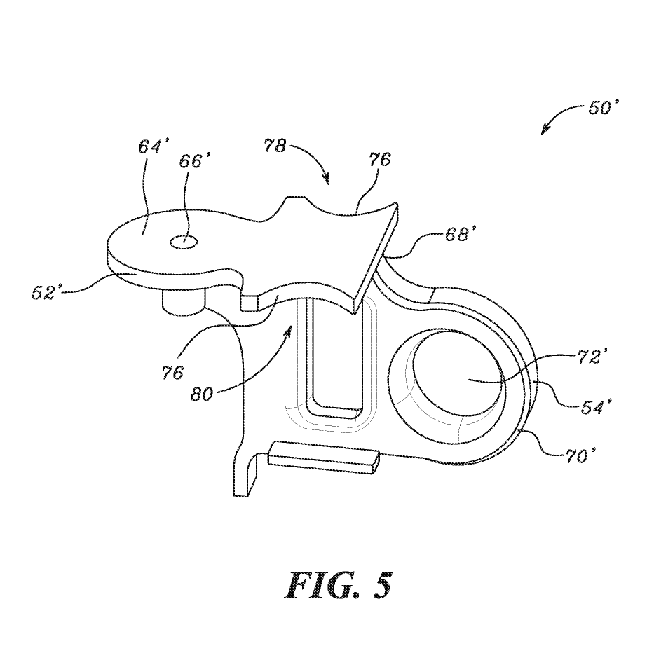

Referring to FIG. 5, a second embodiment of a bracket 50′ is disclosed. The bracket 50′ having a first portion 52′ and a second portion 54′. The first portion 52′ of the bracket 50′ having a first surface 64′ which has an annular opening 66′. The annular opening 66′ is utilized to mount the engine 56 (shown in FIG. 2). Further, the first surface 64′ of the first portion 52′ having grooves 76 on a first side 78 and a second side 80 of the first portion 52′ of the bracket 50′. On the other hand, the second portion 54′ of the bracket 50′ having a first end 68′, and a second end 70′. The first end 68′ is connected to the first portion 52′ of the bracket 50′, and the second end 70′ having an annular opening 72′. The annular opening 72′ is utilized for lifting operations. Further, the bracket 50′ is welded to the frame assembly 36 (shown in FIG. 3) of the machine 10, using the second portion 54′. In this embodiment, a weld joint is also provided between the first portion 52′ and the first plate 58 and the second plate 60 of the first frame 40 (shown in FIG. 3).

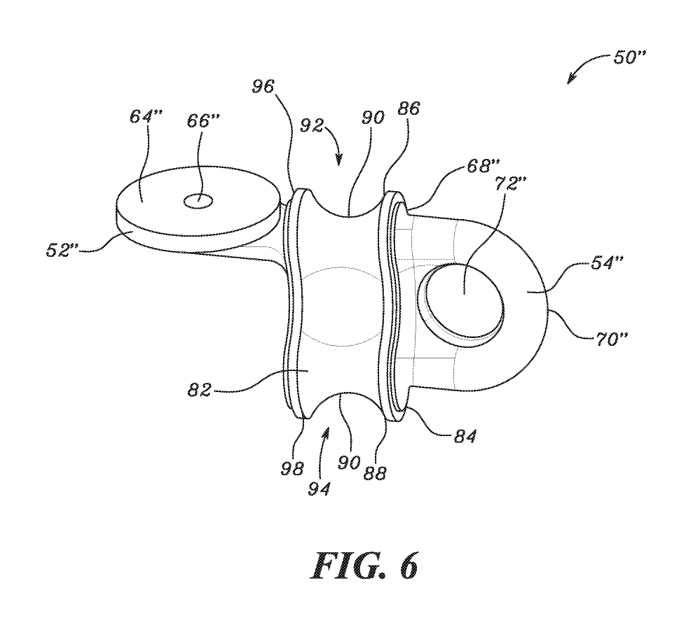

Referring to FIG. 6, a third embodiment of a bracket 50″ is disclosed. The bracket 50″ having a first portion 52″, a second portion 54″, and a third portion 82, The first portion 52″ includes a first surface 64″ having an annular opening 66″ which is utilized for mounting the engine 56 (shown in FIG. 2). As an example, the first surface 64″ is circular in shape. Further, the second portion 54″ of the bracket 50″ having a first end 68″, a second end 70″, and a third end 84. The first end 68″ and the third end 84 of the second portion 54″, are connected to a fourth end 86 and a fifth end 88 of the third portion 82 of the bracket 50″. Further, the second end 70″ having an annular opening 72″, The annular opening 72″is utilized for the lifting operations. Further, the third portion 82 having grooves 90 on a first side 92, and a second side 94, of the bracket 50″. Further, the third portion 82 having a sixth end 96 and a seventh end 98. The sixth end 96 of the third portion 82 is attached to the first portion 52″ of the bracket 50″. Further, the bracket 50″ is welded to the frame assembly 36 (shown in FIG. 3) of the machine 10, at the third end 84 and the sixth end 96.

It should be noted that the bracket 50, 50′, and 50″ of the machine 10 is manufactured by a casting process which is steel casting, or a forging process. It will be apparent to one skilled in the art that the first embodiment, the second embodiment, and the third embodiment, of the bracket 50, 50′, and 50″ respectively mentioned above have been provided only for illustration purposes. Other designs of the bracket 50, 50′, and 50″, may also be utilized, without departing from the scope of the disclosure.

### INDUSTRIAL APPLICABILITY

Referring to FIGS. 3 and 4, the present disclosure provides the mounting assembly 38 of the machine 10, The mounting assembly 38 includes the bracket 50 having the first portion 52 and the second portion 54. The first portion 52 of the bracket 50 is adapted for mounting the engine 56, and the second portion 54 of the bracket 50 is utilized for lifting of the frame assembly 36. For example, the second portion 54 is utilized as a lifting point on a back end of the machine 10 while transferring the machine 10 onto to trailers or rail cars either within the manufacturing facility or in field sites. In another scenario, the second portion 54 is further adapted to provide a tie down point which is used during the transportation. Further, the cavity 74 of the second portion 54 makes the bracket 50 thinner, which helps in reducing the weight of the bracket 50. Further, the first portion 52 of the bracket 50 includes the rubber mount (not shown) that reduces vibrations transmitted from the engine 56 to the first frame 40. The bracket 50 has a single piece design which integrates the first portion 52 used for mounting the engine 56, and the second portion 54 used for lifting the machine 10. Further, the bracket 50 is manufactured by the casting process that is cost effective. Also, the bracket 50 manufactured by casting offers better structural strength and is lighter in weight as compared to a bracket fabricated by welding. The casting process also reduces time and labor effort during manufacturing of the bracket 50. Thus, the bracket 50 is cost effective, eliminates need of welding different parts to make a single bracket, lighter in weight, and easy to manufacture. The manufacturing of the bracket 50 through casting reduces the weld count to 3.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting assembly of a machine comprising:
a bracket having:
a first portion adapted to mount an engine, the first portion having:
a first surface having an annular opening; and
a second portion adapted for lifting operations, the second portion having:
a first end connected to the first portion; and
a second end having an annular opening;
wherein the second portion is adapted to attach to a frame assembly of the machine;
wherein the bracket is manufactured as a single component.
